(19) United States
(12) Patent Application Publication
(10) Pub. No.: US 2008/0263132 A1
(43) Pub. Date: Oct. 23, 2008

(54) APPARATUS AND METHOD FOR EFFICIENT REAL TIME WEB LANGUAGE TRANSLATIONS

(76) Inventor: David Saintloth, Brooklyn, NY (US)

Correspondence Address: Walter J. Tencza Jr., Suite 210, 100 Menlo Park, Edison, NJ, 08837, US

(21) Appl. No.: 11/738,667

(22) Filed: Apr. 23, 2007

(51) Int. Cl. G06F 15/16; G06F 9/00

(52) U.S. Cl. 709/203; 726/11

(57) ABSTRACT

An apparatus comprising a first set of a plurality of client computers, a plurality of node computers in a first branch, and a first set of a plurality of translation service providers is disclosed. Each of the plurality of node computers in the first branch is programmed to route a request for a translation from any one of the first set of a plurality of client computers to any one of the first set of a plurality of translation service providers. The apparatus may further include a view/file server array which may host one view file for each language translated, so that a plurality of view files are hosted by the view/file server array for a corresponding plurality of languages translated.

### FIELD OF THE INVENTION

This invention relates to methods and apparatus concerning language translations over the Internet.

### BACKGROUND OF THE INVENTION

Web chat rooms are increasingly being used by consumer and business organizations to provide real time collaboration capabilities over the Internet. The use of web based technologies for real time collaboration has been facilitated by the availability of high speed disk, high speed computer processors and large computer or electronic memory capacity on computer servers used to host computer software applications which provide web chat room capability for collaboration. Additionally, the development of new technologies to offload required processing and resource requirements of real time collaboration to a client computer, such as a client personal computer, has allowed a new class of such computer software applications directed towards collaboration. Collaboration is the process of real time communications over the Internet employing the dominant methods of preferred communication such as chat (text messaging), data (file sharing), voice (audio) and video.

In recent years the use of Flash™ technology to provide chat room services has been levied heavily by businesses wishing to take advantage of the demand for real time collaboration computer software application tools and features. Prior art computer software applications employ methods for facilitating real time computer file transfer and computer file collaboration between users, methods for formatting messages for display, messages for linking messages to other web accessible documents, methods for allowing for the invitation of guest participants into a web chat conversation via an invitation email (electronic mail), methods for allowing a chat room conversation to be archived in the form of transcripts, and methods for allowing for translating of languages spoken by participants in the room.

There are many implementations of these various features that are available from one or another of many providers of web collaboration and chat computer application software. One example of a popular computer software tool for web chat and collaboration is the WebEx™ family of products. The WebEx™ family of products includes many of the features mentioned previously and enables geographically distributed conferences to be held. However, the WebEx™ family of products requires additional computer software, typically a Flash™ technology plug in script, to be utilized even with a internet web browser. The use of a plug in may inconvenience some users utilizing Internet web browsers that are less popular and do not allow for the installation of flash plugins. Many such browsers' run on small hand held devices, such as web enabled cell phones and PDA's (personal digital assistants). This restricts the usefulness of the WebEx™ collaboration computer software application tools to a subset of the possible areas in which businesses and consumers might like to engage in real time collaboration.

Another provider of conferencing that utilizes flash plugins is Adobe™. Adobe™ provides a computer software application tool called “Adobe Acrobat Connect™”. As with many flash based collaboration computer software tools, many features are provided, and this plethora of features tends to form the bane of the solutions in the form of heavy processing requirements on the clients and expensive licensing fees for consumers. Also, none of the aforementioned web based technologies offer a facility for performing real time language translation between a plurality of participants that could be invited into a chat room. As business needs expand to international markets, the requirement for real time, efficient translations will necessitate extremely scalable and efficient methods to allow large numbers of conversations with large amounts of participants to communicate using different languages in real time with minimal user interaction to engage the translation.

Yet another web conferencing tool available is the Parachat™ family of computer software application products. These products are based on the java™ plug in technology and though full featured require the installation of a computer software plug in on the supported Internet web browsers. The Parachat™ family of products has similar disadvantages to the previously mentioned providers, including the need for an Internet web browser plug in and possibly unacceptable utilization of computer processor power on the client computer. These products also do not provide a method for real time language translation between participants. The feature of real time language translation has also been performed by many existing providers in various ways. A web site for “freetranslate” provides a computer software tool that allows users utilizing AOL (America Online)™ IM (instant messaging) chat room computer software to perform real time translations between themselves and another user. The web site for “freetranslate” provides a convenient way to enable translated chats between up to two users. However, the method used by the web site for “freetranslate” relies on computer software that must be downloaded and installed to the client computer or machine both from the AOL site and from the freetranslate web site to use. Additionally, computer software support for platforms outside of the Windows™ OS (operating system) platform available today is not provided. Neither AOL nor the “freetranslate” web site for example provides versions of their tool for the Unix™ or Linux™ computer operating system platforms. This significantly reduces the usefulness of the “freetranslate” computer software as well because the “freetranslate” computer software requires installation on a client or client computer and is limited to only two communicants. Therefore, its ability to scale to large numbers of web users is reduced. The problem of providing real time multi language translations necessitates a solution that allows for deeply scalable collaboration in multiple languages without incurring a processing penalty for each participant communicating in an Internet web chat room.

### SUMMARY OF THE INVENTION

In one embodiment of the present invention a method is presented for providing for efficient language translation of text based messages between participants communicating in a web chat room using a range of web accessible devices. The present invention in one or more embodiments provides an improvement over existing methods available for real time language translation.

The present invention in one embodiment provides an apparatus comprising a first set of a plurality of client computers, a plurality of node computers in a first branch, and a first set of a plurality of translation service providers. Each of the plurality of node computers in the first branch is programmed to route a request for a translation from any one of the first set of a plurality of client computers to any one of the first set of a plurality of translation service providers.

The apparatus may further include a firewall. The firewall may be configured with respect to the first set of the plurality of client computers and with respect to the plurality of node computers in a first branch so that the request for a translation from any one of the first set of a plurality of client computers must go through the firewall before the request for a translation can be routed by any one of the plurality of node computers in the first branch.

The apparatus may further include first local router. The first local router may be configured with respect to the first set of the plurality of client computers and with respect to the plurality of node computers in a first branch so that the request for a translation from any one of the first set of the plurality of client computers must go through the first local router before the request for a translation can be routed by any one of the plurality of node computers in the first branch.

The apparatus may further include a second set of a plurality of client computers, and an intranetwork. The first set of a plurality of client computers may be configured to communicate with the plurality of node computers in a first branch through the internet, and the second set of a plurality of client computers may be configured to communicate with the plurality of node computers in a first branch through the intranetwork.

The apparatus may further include a plurality of node computers in a second branch. Each of the plurality of node computers in the second branch may be programmed to route a request for a translation from any one of the plurality of client computers to any one of the first set of a plurality of translation service providers.

A second set of a plurality of translation service providers may also be included in the apparatus. The first set of a plurality of translation service providers may be configured to communicate with the plurality of node computers in a first branch through the internet. The second set of a plurality of translation service providers may be configured to communicate with the plurality of node computers in a first branch through the intranetwork.

A second local router may also be provided with the apparatus. The second local router may be configured with respect to the first set of the plurality of client computers and with respect to the plurality of node computers in a second branch so that the request for a translation from any one of the first set of the plurality of client computers must go through the second local router before the request for a translation can be routed by any one of the plurality of node computers in the second branch.

The apparatus may further include a view/file server array comprised of one or more computer servers. The view/file server array may host one view file for each language translated, so that a plurality of view files are hosted by the view/file server array for a corresponding plurality of languages translated. The plurality of view files may include a first view file displaying words in a first language and a second view file displaying words in a second language. A plurality of the first set of a plurality of client computers may receive and display the first view file, and a different plurality of the first set of a plurality of client computers may receive and display the second view file.

The present invention in one or more embodiments also provides a method of routing a request for a translation from any one of a first set of a plurality of client computers to any one of a first set of a plurality of translation service providers, wherein the step of routing is typically performed by a plurality of node computers in a first branch.

### BRIEF DESCRIPTION OF THE DRAWINGS

FIG. 1 shows a block diagram of an apparatus in accordance with an embodiment of the present invention;

FIG. 2 shows a block diagram of an apparatus in accordance with another embodiment of the present invention;

FIG. 3 shows a block diagram of an apparatus in accordance with another embodiment of the present invention;

FIG. 4 shows a block diagram of an apparatus in accordance with another embodiment of the present invention;

FIG. 5 shows a block diagram of an apparatus in accordance with another embodiment of the present invention;

FIG. 6 shows a block diagram of an apparatus in accordance with another embodiment of the present invention;

FIG. 7 shows a depiction of a first image to be displayed on a computer monitor in accordance with an embodiment of the present invention;

FIG. 8 shows a depiction of a second image to be displayed on a computer monitor in accordance with another embodiment of the present invention;

FIG. 9 shows a depiction of a third image to be displayed on a computer monitor in accordance with another embodiment of the present invention; and

FIG. 10 shows a block diagram of an apparatus in accordance with another embodiment of the present invention.

### DETAILED DESCRIPTION OF THE DRAWINGS

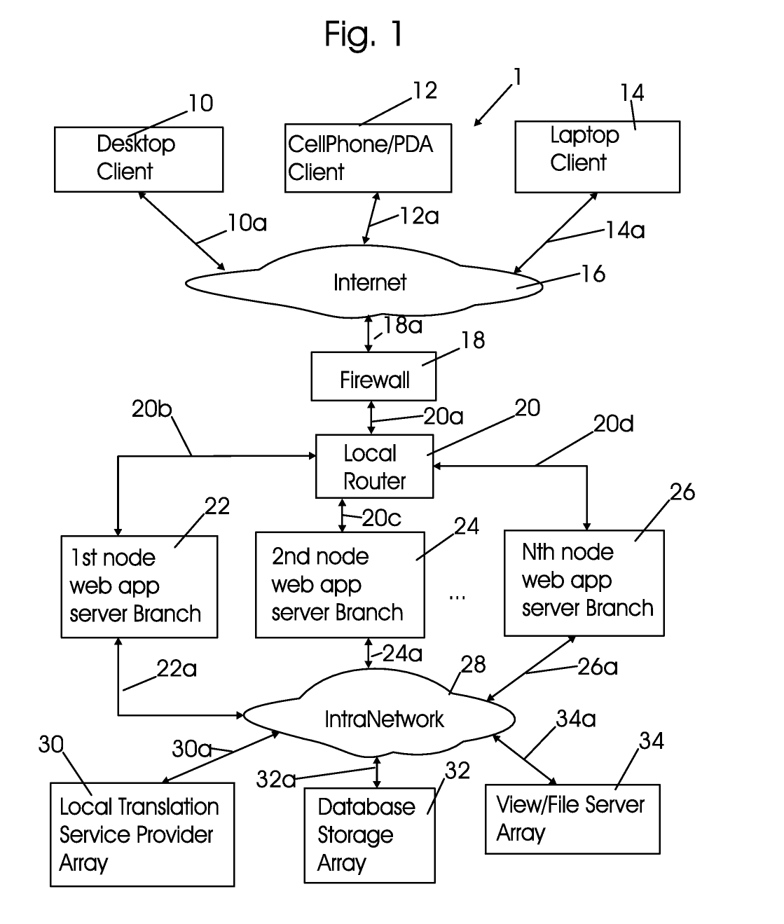

FIG. 1 shows a block diagram of an apparatus 1 in accordance with an embodiment of the present invention. The apparatus 1 includes components such as a desktop client 10, a cell phone/PDA (personal digital assistant) client 12, a laptop client 14, the internet 16, a firewall 18, a local router 20, first, second, and nth web application server branches 22, 24, and 26, an intra network 28, a local translation service provider array 30, a database storage array 32, and a view/file server array 34.

The components 10, 12, 14, and 18 are connected to and/or are in communication with the internet 16 via communications links 10a, 12a, 14a, and 18a respectively. The firewall 18 communicates with the local router via communications link 20a. The local router 20 communicates with the first, second, and nth node web application server branches 22, 24, and 26 via communications links 20b, 20c, and 20d, respectively. The components 22, 24, 26, 30, 32, and 34 are connected to and/or are in communication with the intra network 28 via communication links 22a, 24a, 26a, 30a, 32a, and 34a, respectively.

Each of the desktop client 10, the cell phone/PDA client 12, and the laptop client 14 may include a computer or computer processor, computer or electronic memory, a computer monitor or display, and an interactive device such as a computer mouse and/or computer keyboard.

The view/file server array 34 may include a plurality or array of view/file computer servers, each of which is typically comprised of a computer processor and computer memory. The view/vile server array 34 hosts a plurality of view computer translation files for each of a plurality of primary languages. The plurality of primary languages is selected by a plurality of participants (typically one to one mapped to a plurality of human beings participating via the internet 16) in an Internet conference or chat room. The conference or chat room can have as little as two participants. Internet conference or chat rooms having two participants are typically called “IM” (instant messaging) or “PM” (private messaging) sessions or rooms. As an example, a participant may use the desktop client 10, the cell phone/PDA client 12, or the laptop client 14 or other such device that has access to the internet 16, to communicate via the internet 16 and to thereby participate in the internet conference or chat room.

As more participants join the internet chat room and as each one of these participants selects a primary language, the performance hit on the local translation service provider array 30 goes up with the number of participants but the cost for viewing the translated results for all participants speaking the language remains constant. In the prior art, such as shown by a U.S. Pat. No. 6,996,520, used in a “Transclick™” translation system, the cost for translating and viewing both go up non linearly as more participants join the conversation, as explained further below.

“Performance Hit” means the processing penalty incurred on a translation server provider array, such as the local array 30 in FIG. 1, or a remote translation server provider array. In the prior art one translation view would need to be generated for each of the participants in the Internet conference room or web chat room. In at least one embodiment of the present invention, a method is provided in which a translated view is shared per participant language and not per participant view. Thus the processing penalty (hit) for translating a message from a given participant to all the other participants is reduced by the number of participants speaking the other languages in question. For example, if thirty-five people are speaking Spanish in the room and a user sends a message in English, only a single translation is done to Spanish and the view or computer screen image of that translation is presented to all thirty-five speakers of the Spanish language in that web chat room (or internet conference room) accounting for the reduced processing penalty when compared to traditional methods.

Note that the desktop client 10, laptop client 14, and the cell/PDA client 12 are connecting to the intra network 28 in a distributed fashion via the first, second, or nth nodes web application server branch 22, 24, and 26, respectively. In FIGS. 1, 22, 24, and 26 are multiple nodes of a single branch. The variable n may be any positive number and any number of further web application server branches or nodes may be provided. A client, such as one of components 10, 12, or 14, may logs onto a system, wherein the system includes a plurality of computer servers of nodes 22, 24, and 26. The system of computer servers of nodes 22, 24, and 26, ensures that distribution of requests to access the services are spread among all available nodes, such as one of nodes 22, 24, and 26.

The distribution of requests is performed when a participant, such as one of client computers 10, 12, or 14, requests authentication to the system (which includes nodes 22, 24, and 26 and any further number of nodes) for the purpose of engaging in a chat room session. The initial request is accepted by a node, such as one 22, 24, and 26, based on dynamic load metrics defined for the entire system (i.e. all of nodes 22, 24, and 26) or for each node individually. Thus, a node, such as one of 22, 24, and 26, can be configured to accept a request when the current load level (i.e. the number of participants of 10, 12, and 14, already authenticated through that node and actively being serviced) is below a certain percentage. When load for a given node exceeds this percentage, the request is redirected to another node typically in the same branch. If all web application server nodes in a branch exceed the load percentage, the request is sent to a node on another branch (if it exists) or the request is denied. Denial of an authentication request is increasingly unlikely the more nodes exist in the system and are available to service authentication requests. Each node serves as a distribution point should the load for that node exceed a system defined percentage. Each node randomly redirects to other available nodes, the original URL (the web site address) of the request is normally tied to a particular node so in a sense the URL determines which node is routed to first but the node then determines if the request is handled or routed to another node in the system based on the mentioned load percentage.

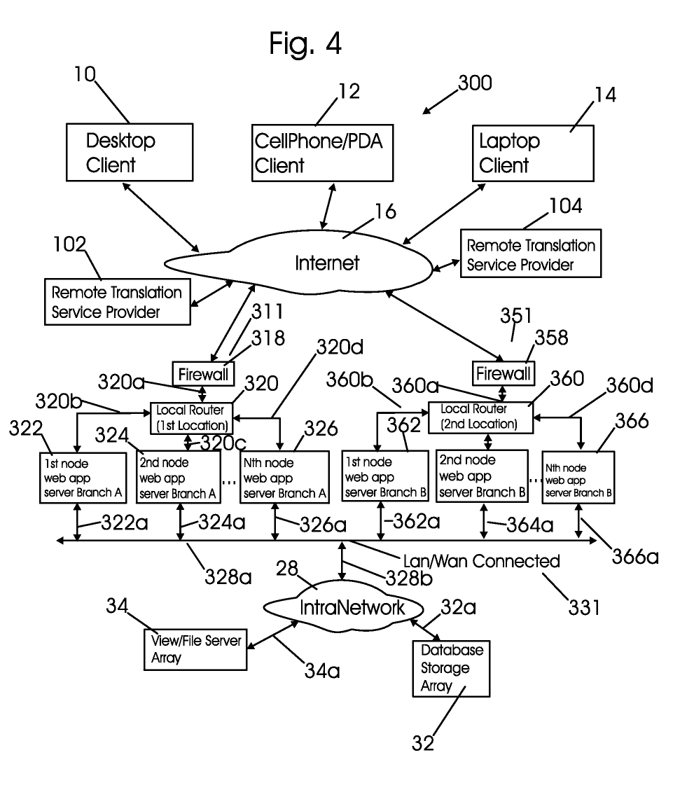

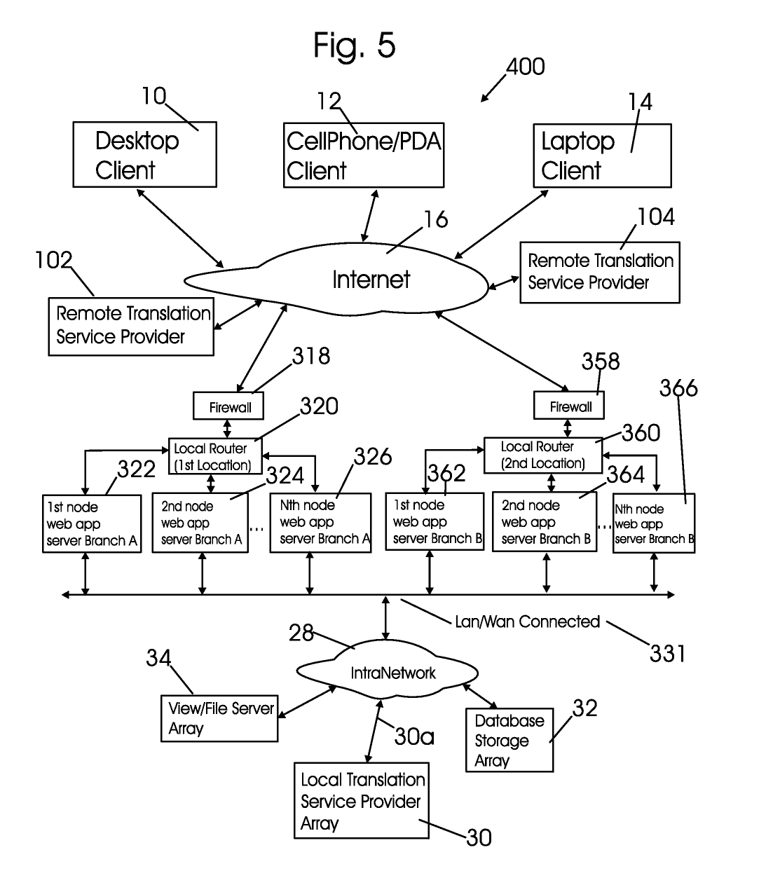

The desktop client 10, the laptop client 14, and the cell/PDA client 12 may be remotely located and may be called remote participants in the Internet web chat room. The remote participants 10, 12, and 14 can be authenticated to any node in an application server array whether it be in nodes 22, 24, and 26 of one branch as shown in FIG. 1 or in multiple branches of nodes 322, 324, 326, 362, 364, and 366 as shown in FIG. 4. The clients, such as 10, 12, and 14, don't care which nodes they use to access the system. The “system” includes nodes 22, 24, 26 in the embodiment of FIGS. 1-3 and nodes 322, 324, 326, 362, 364, and 366 in the embodiment of FIGS. 4 and 5). However, when communicating using a method in accordance with an embodiment of the present invention, the clients 10, 12, and 14 share the processing requirements for viewing the real time communications of their selected primary language.

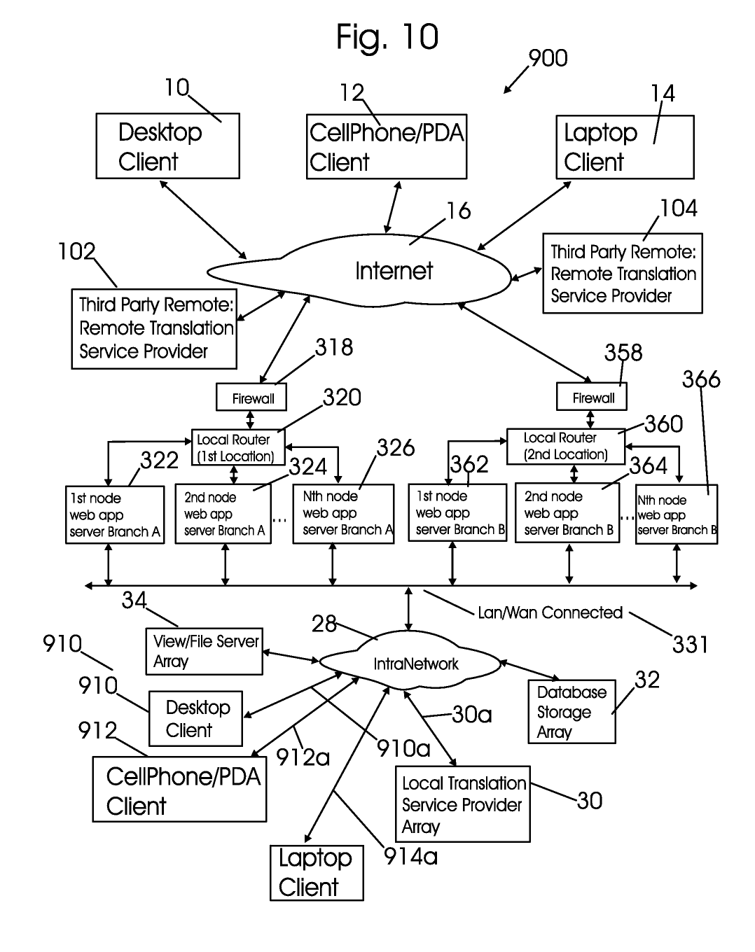

The distributed web application server nodes of the plurality of possible branches, such as 322, 324, and 326 of a first branch, and 362, 364, and 366 (of a second branch) in FIG. 4, are able to present the different language specific translated views to the different remote clients (such as for example one of 910, 912, and 914 in FIG. 10) efficiently and in a scalable manner. Scalability is improved when more web application nodes are added to the “system” (i.e. to the collection of nodes, such as 322, 324, 326, 362, 364, and 366) which then allows more participants (i.e. more clients or client computers like 10, 12, and 14 of FIG. 1) and more rooms to be hosted on the system in the form of connecting clients. Additional capacity can be procured simply by adding additional nodes to the web application server branch or by adding a new branch. In the present application typically, a “branch” encapsulates (or is a grouping of) a plurality of nodes. Typically a “branch” means a logically related grouping of nodes, such as nodes 22, 24, and 26 of FIG. 1. Typically all nodes in all branches allow remote clients to authenticate and join a conversation. In FIG. 5, the two branches (branch A and branch B) were separated geographically but for the purposes of performing the real time language translation, the clients, such as 10, 12, and 14, don't care where the authenticating node is or how many nodes there are.

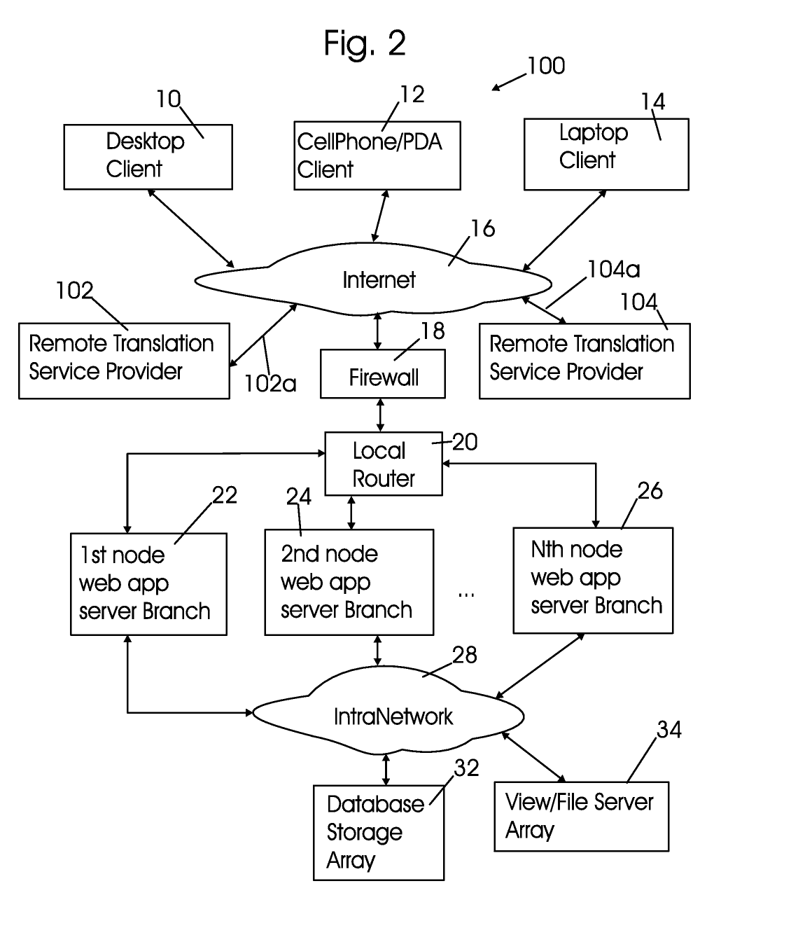

FIG. 2 shows a block diagram of an apparatus 100 in accordance with another embodiment of the present invention. The apparatus 100 includes the components of the apparatus 1 of FIG. 1 with the exception of the local translation service provider array 30, which has been eliminated. The apparatus 100 also includes additional components 102 and 104, which are not included in the apparatus 1 of FIG. 1. The component 102 can also be called a third party remote: remote translation service provider. The component 104 can also be called a third party remote: remote translation service provider.

Each of the components 102 and/or 104 may be a remote or third party translation service provider, such as “google.com™” or “babelfish.com™”. The components 102 and/or 104 may provide translations of the views, and/or input typed in by a user into a computer, such as into the desktop client 10, cell phone/PDA client 12, and laptop client 14, shown in FIGS. 1 and 2. The views may be seen by all participants in the internet web chat room or conference room. In accordance with one embodiment of the present invention, a method is provided which is not dependent on any particular remote service and can easily be changed to accommodate different remote providers or different third party translation services, in a trivial fashion on a per participant basis.

Each of the desktop client 10, laptop client 14, or cell/PDA client 12 typically connects or communicates as a remote agent through the internet 16 but the translations provided by embodiments of the present invention will work as well on uniquely defined internal clients (clients that would be also behind the firewall 18). FIG. 10 shows a diagram illustrating an embodiment where the participants are accessing the internet chat room from remote (clients 10, 12, and 14 access from remote locations) and local (internal) (clients or participants 910, 912, and 914 access from local locations) locations.

The components 10, 14, and 12 may be located locally or remotely and translations can be provided for both remote and local clients. Typically, the difference between “remote” and “local” is that a remote client (such as any of components 10, 12, and 14 in FIG. 1) is connected directly through the internet 16 to the intra network 28 and a local client such as 910, 912, and 914 in FIG. 10 are connected to the internet 16 by routing out through the same network (in this case intra network 28) as the network that provides the chat room/translation service to get access to the internet 16.

In FIG. 10 is an illustration of locally connected clients 910, 912, and 914 communicating with the intra network 28 to gain access to the internet 16 and thereby to internet resident remote translations service providers, such as components 402 and 404 shown in FIG. 10, and other internet based resources. So “local” only means in context to the network providing the chat room service (in this case local to the aforementioned n-application server nodes 322, 324, 326, and 362, 364, and 366 shown in FIG. 10 behind the firewall 318 and 358. Typically there aren't any client restrictions for a properly configured hosting network.

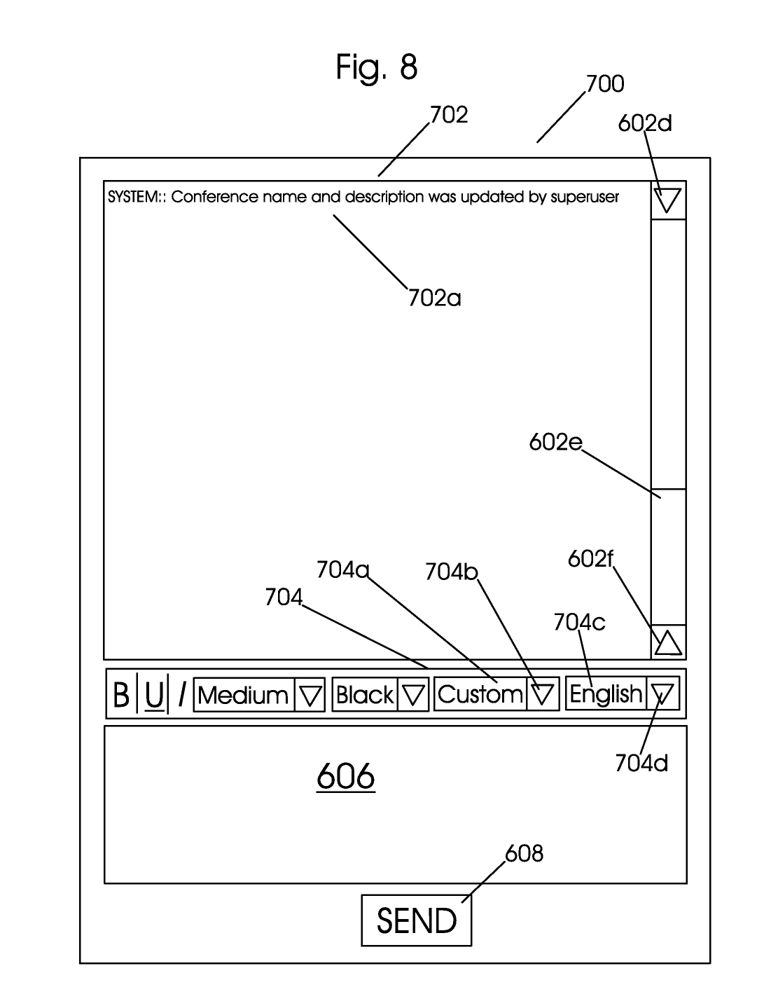

Distributed authentication for all participants combined with the fact that each client of clients 10, 12, and 14, can choose their own primary language regardless of the language spoken by other participants, such as other client computers, in the internet chat room allows participants to use different translation service providers, such as one of 102 or 104, or one of any number of further third party remote translation service providers not shown, if desired. This redundancy allows the translation capability provided by the apparatus 100 in FIG. 2 to remain robust against failure of any one third party translation service provider, such as failure of one or other of 102 and 104. A method, in accordance with an embodiment of the present invention, is typically more robust against failure of any translation service provider whether it be local or remote. Note that the clients, such as one of 10, 12, and 14, typically choose the desired provider, such as 102 or 104 in FIG. 2, from a drop down list accessible from field 704 in FIG. 8. Any of the clients, such as 10, 12, and 14, or an individual operating a client device, is free to choose a remote provider such as Google™, freetranslate™, and Babel fish™, or a single local provider (“custom”) using the field 704b for displaying a drop down list.

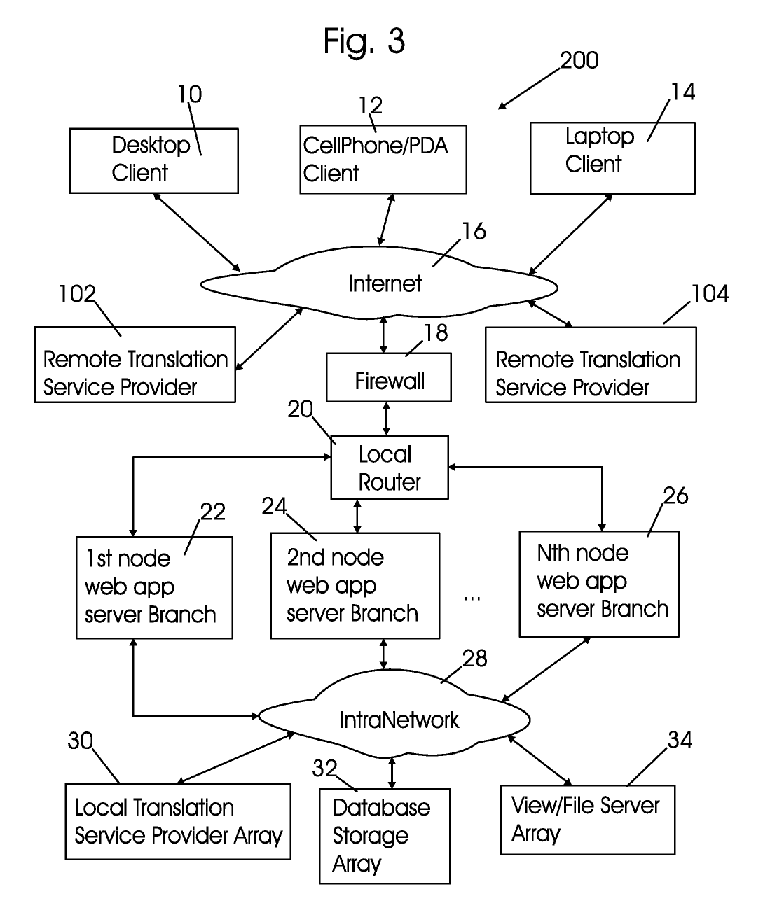

FIG. 3 shows a block diagram of an apparatus 200 in accordance with another embodiment of the present invention. The apparatus 200 includes the components of the apparatus 100 of FIG. 2 with the exception of the addition of a local translation service provider array 30, which has been added.

FIG. 3 illustrates the use of both a local translation service provider array, such as 30 and remote third party translation providers, such as 102 and 104. The components 30, 102, and 104 are selected on a per user or participant basis for translation from a participant's primary language to the primary languages spoken by other participants in the Internet chat room. Again, the important factor is that translations are done per language and not per user and this dramatically improves the efficiency of the translation operation as more and more users enter the conversation, i.e. enter the Internet chat room. The option to use local and/or remote translation providers by the participants ensures robust translation capabilities are available to all users should any of the translation providers be inaccessible or fail.

FIG. 4 shows a block diagram of an apparatus 300 in accordance with another embodiment of the present invention. The apparatus 300 includes the desktop client 10, cell phone/PDA client 12, laptop client 14, and third party remote translation service providers 102 and 104 connected or in communication with the internet 16 as referred to in FIGS. 2 and 3. The apparatus 300 also includes a set 311 of components concerning a local router 320 at a first location and a set 351 of components concerning a local router 360 at a second location.

The set of components 311 includes a firewall 318, the local router 320, first node web application server branch A 322, second node web application server branch A 324, and nth node web application server branch A 326. Similarly, the set of components 351 includes a firewall 358, the local router 360, a first node web application server branch B 362, a second node web application server branch B 364, and an nth node web application server branch B 366. Note that typically each branch is a collection or plurality of nodes. Typically, there are “n” nodes to a branch specified by a specific given location. Typically, each branch has “n” nodes and each node is able to provide necessary translation services to requesting local clients (such as 910, 912, and 914 shown in FIG. 10) and remote clients, such as 10, 12, and 14 shown in FIG. 4. Each nodes, such as each of nodes 322, 324, 326, 362, 364, and 366 is an individual computer and each node performs the authentication and routing of requests to and from the translation service providers, such as local translation service provider array 30 and remote translation service providers 102 and 104, and to and from the database storage array 32 and view/file server array 34.

The local router 320 communicates with the components 318, 322, 324, and 326 via communications links 320a, 320b, 320c, and 320d, respectively. Similarly, the local router 360 communicates with the components 358, 362, 364, and 366 via communications links 360a, 360b, 360c, and 360d, respectively.

The components 322, 324, 326, 362, 364, and 366 communicate with communications links 328a and 328b through communications links 322, 324a, 326a, 362a, 364a, and 366a respectively. The communications link 328b communicates with intra network 28. Intra network 28 also communicates with view/file server array 34 and database storage array 32 via communications links 34a and 32a, respectively.

FIG. 4 illustrates the use of remote translation servers, such as 102 and 104, on multiple web application server branches of nodes at first and second locations, i.e. set 311 of components at a first location and set 351 of components at a second location. This illustrates the ability to provide translations to remote clients such as 10, 12, or 14 in FIG. 1 or local clients such as 910, 912, and 914 in FIG. 10 using geographically distributed authentication and translation nodes. The view/file server array 34 is accessible to all branches (of which there can be any number) via the local area or wide area network connection or communications link such as 331 provided by the intra network 28.

The act of translating participant conversations, such as from one of clients 10, 12, or 14 in the internet web chat conference room is unrelated to the number of branches or nodes used to authenticate the participants.

FIG. 5 shows a block diagram of an apparatus 400 in accordance with another embodiment of the present invention. The apparatus 400 includes the components shown in FIG. 4 and also additionally includes a local translation service provider array 402 that communicates with the intra network 328 via a communications link 402a.

FIG. 5 illustrates the use of a local translation computer server 402 and remote translation computer servers 102 and 104 on multiple web application server branches of nodes at first and second locations (components of set 311 and set 351, respectively). Again, this illustrates the ability to provide translations to remote clients or client computers, such as 10, 12, or 14 in FIG. 1 or local clients or client computers, such as one of 910, 912, and 914 shown in FIG. 10 using geographically distributed authentication and translation nodes. The view/file server array 34 is accessible to all branches (of which there can be any number) via the local area or wide area network connection 331 provided by the intra network 28.

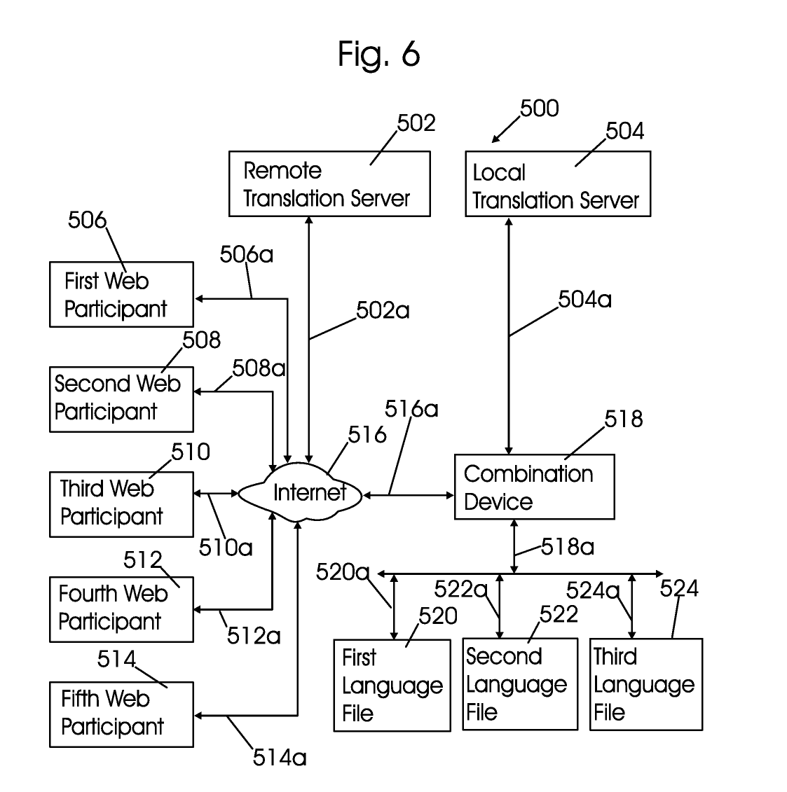

FIG. 6 shows a block diagram of an apparatus 500 in accordance with another embodiment of the present invention. The apparatus 500 includes components, such as a remote translation computer server 502, a local translation computer server 504, a first web participant or computer 506, a second web participant or computer 508, a third web participant or computer 510, a fourth web participant or computer 512, a fifth web participant or computer 514, the internet 516, a combination device 518, a first language file 520, a second language file 522, and a third language file 524.

The components 502, 506, 508, 510, 512, 514, and 518 communicate with the internet 516 via communications links 502a, 506a, 508a, 510a, 512a, 514a, and 518a, respectively. The local translation server 504 communicates with the combination device 518 via communications link 504a. The combination device 518 may include a plurality of communications devices. The type of communication device used by each participant can vary. Combination device 518 communicates with the first, second, and third language files 520, 522, and 524, respectively, via communications links 518a, 518b, and 520a, 522a, and 524a, respectively.

Each of the web participants 506, 508, 510, 512, and 514 may include a computer that is operated by a human being.

FIG. 6 illustrates in detail the efficient way in which translations are handled in an Internet web chat conference room. Each of the web participants 506, 508, 510, 512, and 514 may be a remote or local client web access device. The components 506, 508, 510, 512, and 514 are joined as participants in a web conference chat room, with each user speaking his/her own chosen primary language.

Web participants 506, 508, 510, 512, and 514 are simple representations of a client attached to the “system” and engaged in a conversation/chat session. The users of the participants 506-514 may be speaking, or inputting into the computers or participants 506-514, different languages. For example, users of participants 506, 510, and 514 may be inputting German, a user of participant 508 may be inputting English, and a user of participant 512 may be inputting French. The number of languages, in this case three, matches the number of view files, in this case files 520, 522, and 524 shown in FIG. 6. Participant devices 506, 510, and 514 will display on for example a computer monitor file 520, while participant device 508 will display file 522, and participant device 512 will display file 524. Thus, three language view files (language files or language view files 520, 522, and 524) are generated for all the five web participants and if fifty more participants entered the room to chat and also chose any of those three languages still the same number of view files is all that would be needed (i.e. only three view files 520, 522, and 524 would be needed in this example). This is where savings are made in the processing of translated messages and in the viewing of those messages by all participants in the room.

The communications links 506a, 508a, 512a, 514a, 516a, and 502a are simple representations of connection lines of the various devices that touch the “internet” 516. Thus all connecting or communications links or devices could be geographically distributed across the globe.

Internet 516 is a simple cloud representation of the network devices and servers that form the Internet network and to which the various clients and devices described previously are connected.

Remote translation service provider/server 502 is a simple representation of a remote translation server. The terms “server”, “server array” or “provider” as used in this application are interchangeable. The component 502 may be the same as any one of the components 102, and 104.

The combination device 518 is a block simplifying the separate components 318, 320, 322, 324, 326, 34, 358, 362, 364, 366, and 32 into one block for more easily describing an aspect of an embodiment of the present invention, namely that translations are performed per translated language view (items 520, 522, and 524) and not per number of engaged participants (in this case five participants).

Communication links 518a, 520a, 522a, and 524a are simplified representation of network connections (which could be local area network or wide area network) to the view file server array 34 on which the view language files (items 520, 522, and 524) are hosted and made accessible to the participants from.

Components 520, 522, and 524 are simplified representations of view file server language translation files hosted on the view file server array 34 that correspond to the current set of selected languages being spoken in the chat room by the participants (506, 508, 510, 512, and 514 in FIG. 6)

The messages and the views of the translated results from participants or users of participant devices 506, 508, 510, 512, and 514, speaking other languages are sent through the Internet 516. The messages are then sent from the Internet 516 to the combination device 518 via communications link 516a. The combination device 518 is a block representation of items 18, 20, 22, 24, 26, 28, 32 as shown in FIGS. 1-3 and items 318, 320, 322, 324, 326, 328, 332 and 358, 360, 362, 364, and 366 as shown in FIGS. 4, and 5). The view/file server array (typically including one or more server computers), such as 34 shown in FIGS. 1-3 and 34 shown in FIGS. 4 and 5, hosts a view file for each of the languages spoken in the internet web chat conference room, not each participant. This illustrates clearly that as participant count increases computational cost for translating to the other languages increases in a fashion linear with the number of spoken languages.

The remote translation service provider or server 502 may be, for example, Google™or Babel fish™, and on the local network a local translation server 504 or array (such as an array of server computers) may be similar to local translation server array 402 of FIG. 5. Again translation is not related to the location of the translations server provider, such as 502 or 504, used to write translations to the view files for each language spoken in the room.

One or more embodiments of the present invention allow for a reduction in the processing power required to perform translations compared to prior art methods that perform translation and message delivery for each participant in the room. FIG. 6 illustrates how this is performed, in one embodiment, by showing several participants 506, 508, 510, 512 and 514, all communicating in an Internet chat room with one of three languages. The three languages spoken by the five participants have associated language view files 520, 522, and 524 hosted on the file view server array, such as file/view server array 34 shown in FIGS. 1-5. Traditional prior art techniques involve translating each message from a participant's language to another participant's language and then performing this process for each of the remaining participants if the languages are different. The translated result must then be sent to all participants that are speaking the translated language. As the number of participants speaking the translated language increases, the number of message deliveries also increases as well as the associated processing penalty. A method employed in accordance with at least one embodiment of the present invention translates each message from each participant only once as traditional prior art methods do but delivers the translated message only to one participant view file and not to each participant as traditional prior art methods do. In addition to the saving in processing requirements as a result of only delivering the translation to a view file, there is the advantage that, in an embodiment of the present invention, the translated result is made available to all participants simultaneously, (since the participants view it simply by requesting the file as an ordinary web page). This aspect of an embodiment of the present invention allows the web application server nodes, such as 22, 24, and 26 in FIGS. 1-3, to which the participants are authenticated to each serve the view file requested by the connected participant independent of the other nodes.

Another advantage of a method in accordance with an embodiment of the invention is that simultaneous updates to the view files are protected against concurrent write errors by the intrinsic IO (input/output) blocking that is performed for writing of files to most computer operating systems. This ensures that message translations being sent from large numbers of participants are not garbled due to synchronization errors during message delivery. Though traditional prior art methods of translation employing delivery of the translated message to each participant are not subject to message garbling, these traditional prior art methods typically do incur the mentioned additional penalty for the multiple deliveries per participant that one or more embodiments of the present invention do not incur. Another advantage of one or more embodiments of the present invention over existing prior art methods involves the use of chaining (composed implicit translations) of local and/or remote translation service providers (such as remote translation service provides 102 and 104, local translation service provider array 30 in FIG. 10, remote translation service provider 502 and local translation service provider 504 in FIG. 6, to perform translations between language pairs that are not explicitly supported by the translation service providers.

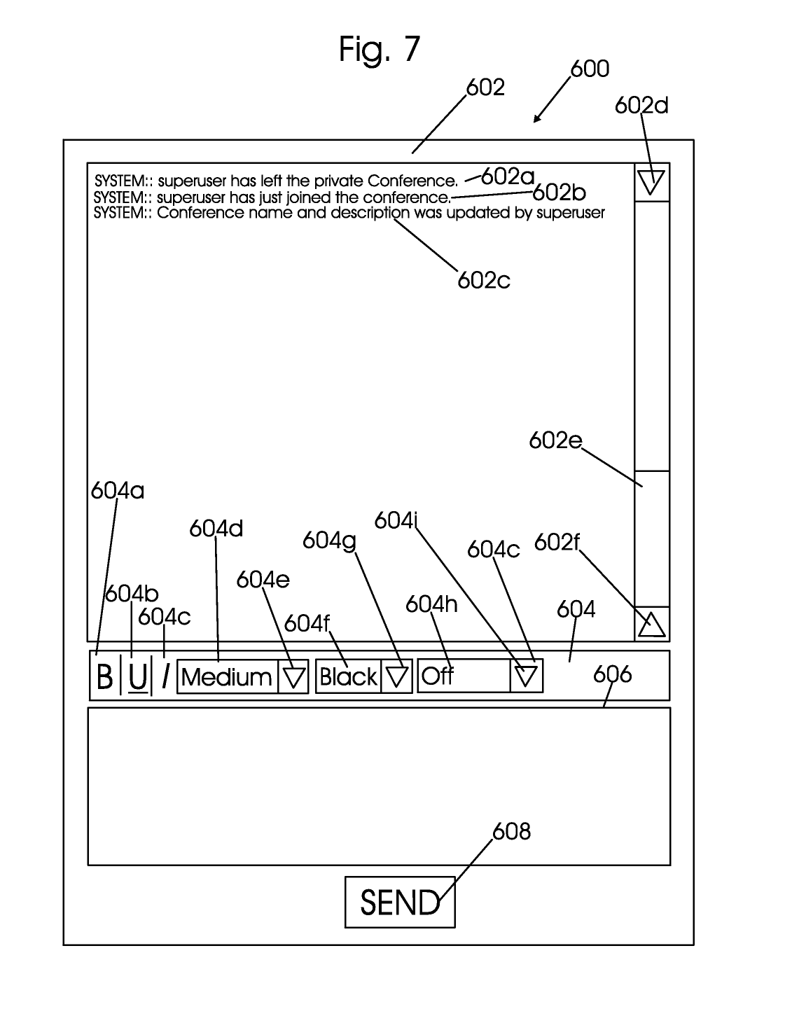

FIG. 7 shows a depiction of a first image 600 to be displayed on a computer monitor of one or more of the web participants 506, 508, 510, 512, and 514 shown in FIG. 6. The first image 600 includes fields 602, 604, 606, and 608.

Field 602 displays a series of messages 602a, 602b, and 602c in FIG. 7. Field 602 is displayed to all of the web participants 506-514. The messages 602a, 602b, and 602c indicate that a particular user (“superuser”) has left the web Internet chat conference, has joined the web internet chat conference, and that the conference name and description was updated by the particular user. The field 602 includes scroll arrows 602d and 602f and scroll bar 602e, which can be used to scroll through the information shown in the field 602. The series of messages 602a, 602b, and 602c may be status messages that display when users ingress and/or egress the Internet web chat room.

The field 604 includes fields' 604a-i. Fields 604a-c can be clicked on using a computer mouse of the particular web participant computer of 506-514, to bold, underline, or italicize, respectively, the text shown in field 602. Field 604d shows a drop down selector for the font size desired by the participant. Selecting from the options selects the desired size of entered message text for that user. Field 604f shows a drop down selector for a font color desired by the participant. The text of the chat that they enter will be displayed in the selected color. Field 604h shows the drop down selector for the participant to choose the desired translation service provider, such as Google™, Babel fish™, or custom, represented by the local and remote translation service providers (such as local translation service provider 30 and remote translation service providers 102 and 104 of FIGS. 1-5.

Field 606 is for typing in a message that will be sent to the Internet chat room for display in field 602 to all the web participants 506-514. Clicking on the send button 608 sends the message typed in field 606.

FIG. 7 shows the default state of the Internet web chat conference interface, the “off” drop down selection shown in field 604h assumes a primary language of English.

FIG. 7 also illustrates the fact that the participants 506-514 in the internet web chat conference room only need select their own primary language in order to engage in real time translations in accordance with an embodiment of the present invention. The participants 506-514 do not need to know what other languages other participants are conversing in. The reason this is so was explained at least in part which reference to FIG. 6, which showed that translations are performed per primary language used in the room not per user or participant of participants 506-514. All users speaking a particular primary language converse using the same file view document (as shown in FIG. 6) thus translation is not performed between participants speaking the same language, only translations of messages from one language view file to another require translation. Thus if an internet chat room contains participants who are only speaking one primary language no additional translation cost at all is incurred, this ensures that translations are done only on agent demand as determined by primary language and this makes the process of translating for large numbers of participants efficient.

FIG. 8 shows a depiction of a second image 700 to be displayed on a computer monitor of the web participants 506-514 in accordance with another embodiment of the present invention. The image 700 includes a field 702, which is the same as the field 602, except the text displayed has changed. The image 700 includes the fields 606 and 608, which remain the same as in FIG. 7. The image 700 includes the field 704 which is the same as the field 604 in FIG. 7 except as will be noted. The field 704 includes fields' 704a-b which correspond to fields 604h-i in location, but which show the word “Custom” along with a pull down arrow. The field 704 also includes an additional field 704c, showing the word “English” by default but the default language can be set to a user defined default that is not English and is accommodated by the translation service providers listed and a pull down arrow 704d.

FIG. 8 shows the default state of the conference interface for enabling or disabling translations on agent demand, the “off” drop down selection shown previously in field 604h of FIG. 7 has been changed to “custom” shown in FIG. 704a (by clicking on drop down arrow 704b and selecting “custom”). The custom option is provided by a local translations service provider array, such as array 30 of FIG. 5. Though described as “local”, the array 30 can actually be located anywhere that can be uniquely routed to and from the web application server nodes, such as nodes 322, 324, and 326 or 362, 364, and 366. The “custom” option would invoke use of the local translation service provider array 30 of FIGS. 1-5.

The word “English” displayed in field 704c of FIG. 8 is the default primary language set when a translation service provider (such as custom, Babel fish™, Google™ . . . etc.) is chosen. The host is free to provide as many translation languages as their system wishes to accommodate without interfering with or reducing the efficiency of the “translations per view language view not per participant” process.

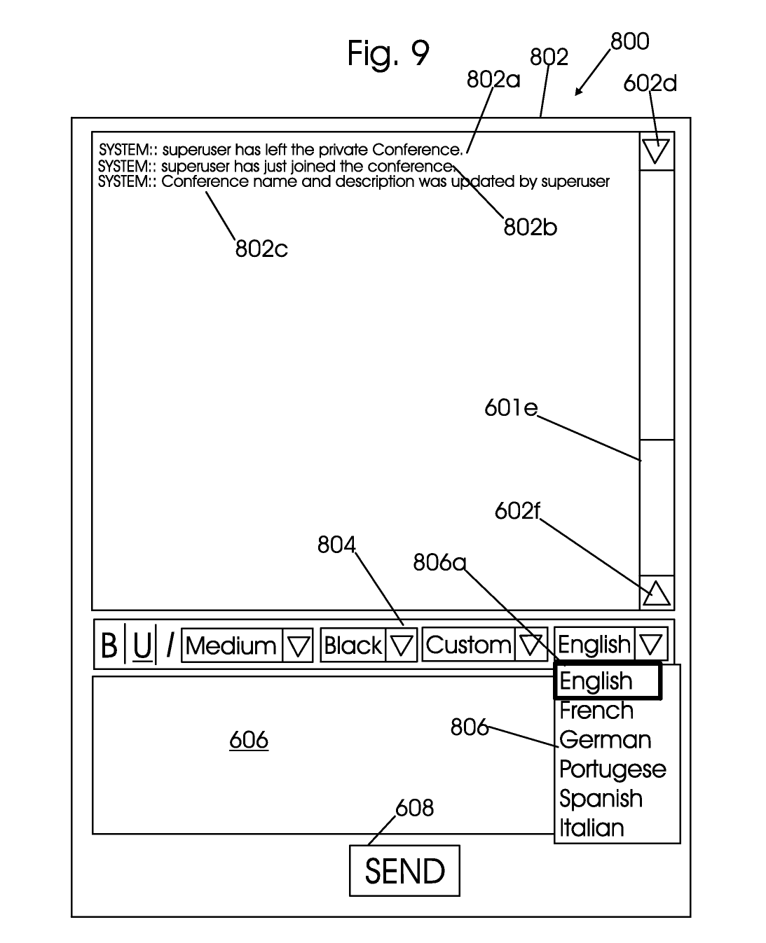

FIG. 9 shows a depiction of a third image 800 to be displayed on a computer monitor of the web participants 506-514, shown in FIG. 6, in accordance with another embodiment of the present invention. The image 800 includes a field 802, which is the same as the field 602, except the text displayed has changed. The image 800 includes the fields 606 and 608, which remain the same as in FIG. 7. The image 800 includes the field 804, which is the same as the field 704 in FIG. 8. The image 800 also includes a field 806 that is a drop down menu that appears following the selection of drop down arrow 704 next to “English” field 704c shown in FIG. 8. The field 806 includes a list of languages that can be selected, including “English”, “French”, “German”, “Portuguese”, “Spanish”, and “Italian”. In this case, the English language has been selected, such as by a computer mouse clicking on it, as shown by the highlighting or box 806a. The language options shown in the diagram are illustrative and do not enclose all possible options, a multiplicity of distinct languages can be provided for depending on languages provided by the selected translation service provider,

FIG. 9 illustrates selection of a remote third party translation server agent, such as google™. As mentioned before, this third party agent can be selected independently for each participant in the conference allowing for redundancy in case of failure.

FIG. 10 shows a block diagram of an apparatus 900 in accordance with another embodiment of the present invention. The apparatus 900 includes the components shown in FIG. 5 and also additionally includes a local desktop client 910, a local cell phone/PDA client 912, and a local laptop client 914, which communicate directly with the intranet 28 via communications links 910a, 912a, and 914a.

Clients 10, 12, and 14 are simple representations of client devices with Internet access and the ability to display a chat room user interface in a browser window on a computer monitor. They are connected to the translation system (which includes nodes 322, 324, 326, 362, 364, and 366) via the Internet 16.

Internet 16 is a simple representation of the complex web of networked computers and servers that form the World Wide Web and through which clients, such as 10, 12, and 14 connect to the system (nodes 322, 324, 326, 362, 364, and 366).

The remote translation service providers 102 and 104 are simple representations of remote providers of translation services accessed through the Internet by the node web application servers that include 322, 324, 326, 362, 364, and 366 in FIG. 6.

Firewalls 318 and 358 are simple representations of local firewall devices separating application server branches and nodes (322-326 and 362-366) from the Internet 16. These perform filtering of requests for resources in a standard Internet connected network.

Local routers 320 and 360 are simple representation of local routers which redirects requests coming from remote clients, such as 10, 12, and 14 to the “n” nodes (322-326 and 362-366) on the respective branches in the separate locations. Though only two location branches are shown here, there can be “k” number of branches fielding requests from clients.

Local area network 331 is a simple representation of a local area network or wide area network used to connect branches routed by local routers, such as 320 and 360. Local area network 331 or more than one similar local area network, can be widely geographically dispersed and are connected via the intranet 28.

Nodes 322, 324, 326, 362, 364, 366 are simple representations of the authorization nodes for chat room sessions engaged by clients (such as 10, 12, and 14). There can be a multiplicity of nodes as indicated by the nth nodes 326 and 366 and a multiplicity of branches to which these nodes belong. In FIG. 6, note the nodes are on two separate local networks that are connected using intranet 28. These components including intranet 28 and nodes 322, 324, 326, 362, 364, and 366) are loosely what can be called “the system” as they are the nodes to which remote clients must authenticate to get access to the language translation features in the real time chat room.

Intranet 28 is a simple representation of an intranet of all devices that form the local area network or wide area network that allow all the branches and their associated nodes (such as 322-326 and 362-366) to communicate with remote clients (such as 10, 12, and 14), local clients (such as 910, 912, and 914, such in FIG. 10), the view file server array 34, the local translation service provider array 30, and the database storage array 32.

View/file server array 34 is a simple representation of the view file servers that host the view files generated for different languages in conversations (chats) in progress by the various connecting participants (such as 10, 12, and 14) above)

Database storage array 32 is a simple representation of a database storage server array that stores participant authorization information for validating new requests and restoring various user defined settings for created chat rooms (default colors, default language, etc.)

Local translation service provider array 30 is a simple representation of a local translation service provider array that provides translations for messages of participants which are relayed to the authorizing node (such as one of 322-326 or 362-366), which then updates the view/file server array file for the translated language hosted on the view file server array 334 so that all participants (such as 10, 12, and 14) can view the translation simultaneously.

Clients 910, 912, and 914, are simple representations of locally connected client machines/devices that can also join into the chat/conversation and utilize local or remote translation facilities to communicate.

The available languages for the selected third party translation provider can change depending on the selected provider. Google™ displays five languages but the number of languages shown for other selected translation engines/providers can be different. As long as the provider/engine have one language in common (English) the translations can be chained (composed implicit translations) between provider languages to allow translations between language pairs that are not provided by any of the selected agents. For example, google™ does not provide translations from Portuguese to Italian or Italian to Portuguese but a translation on agent demand system in accordance with an embodiment of the present invention uses chained translations to allow participants speaking Portuguese to communicate with participants speaking Italian. It does this by translating from each language to an intermediate language, (eg. English) then translating from the intermediate language to the destination language. This works even if one user is using Google™ as their translation provider/engine and another is using Babelfish™. Chaining works across selected participant language service providers/engines making it very robust and efficient. There is a loss in precision in the final translation when chaining is incurred but the casual language and grammar used in many web internet chat or conference conversations allows original intent to be preserved, also the language translation tools available are becoming increasingly efficient at translating nuances of meaning that are not immediately extracted through grammatical filtering of the phrases translated from language to language.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first set of a plurality of client computers;
a plurality of node computers in a first branch; and
a first set of a plurality of translation service providers;
wherein each of the plurality of node computers in the first branch is programmed to route a request for a translation from any one of the first set of a plurality of client computers to any one of the first set of a plurality of translation service providers.

2. The apparatus of claim 1 further comprising
a firewall; and
wherein the firewall is configured with respect to the first set of the plurality of client computers and with respect to the plurality of node computers in a first branch so that the request for a translation from any one of the first set of a plurality of client computers must go through the firewall before the request for a translation can be routed by any one of the plurality of node computers in the first branch.

3. The apparatus of claim 1 further comprising
a first local router; and
wherein the first local router is configured with respect to the first set of the plurality of client computers and with respect to the plurality of node computers in a first branch so that the request for a translation from any one of the first set of the plurality of client computers must go through the first local router before the request for a translation can be routed by any one of the plurality of node computers in the first branch.

4. The apparatus of claim 1 further comprising
a second set of a plurality of client computers;
an intranetwork;
wherein the first set of a plurality of client computers is configured to communicate with the plurality of node computers in a first branch through the internet; and
wherein the second set of a plurality of client computers is configured to communicate with the plurality of node computers in a first branch through the intranetwork.

5. The apparatus of claim 1 further comprising
a plurality of node computers in a second branch;
wherein each of the plurality of node computers in the second branch is programmed to route a request for a translation from any one of the plurality of client computers to any one of the first set of a plurality of translation service providers.

6. The apparatus of claim 1 further comprising
a second set of a plurality of translation service providers; and
an intranetwork;
wherein the first set of a plurality of translation service providers is configured to communicate with the plurality of node computers in a first branch through the internet; and
wherein the second set of a plurality of translation service providers is configured to communicate with the plurality of node computers in a first branch through the intranetwork.

7. The apparatus of claim 3 further comprising
a second local router;
a plurality of node computers in a second branch;
wherein the second local router is configured with respect to the first set of the plurality of client computers and with respect to the plurality of node computers in a second branch so that the request for a translation from any one of the first set of the plurality of client computers must go through the second local router before the request for a translation can be routed by any one of the plurality of node computers in the second branch.

8. The apparatus of claim 1 further comprising
a view/file server array comprised of one or more computer servers;
wherein the view/file server array hosts one view file for each language translated, so that a plurality of view files are hosted by the view/file server array for a corresponding plurality of languages translated;
wherein the plurality of a view files includes a first view file displaying words in a first language and a second view file displaying words in a second language;
wherein a plurality of the first set of a plurality of client computers receives and displays the first view file; and
wherein a plurality of the first set of a plurality of client computers receives and displays the second view file.

9. A method comprising:
routing a request for a translation from any one of a first set of a plurality of client computers to any one of a first set of a plurality of translation service providers; and
wherein the step of routing is performed by a plurality of node computers in a first branch.

10. The method of claim 9 further comprising
configuring a firewall with respect to the first set of the plurality of client computers and with respect to the plurality of node computers in a first branch so that the request for a translation from any one of the first set of a plurality of client computers must go through the firewall before the request for a translation can be routed by any one of the plurality of node computers in the first branch.

11. The method of claim 9 further comprising
configuring a first local router with respect to the first set of the plurality of client computers and with respect to the plurality of node computers in a first branch so that the request for a translation from any one of the first set of the plurality of client computers must go through the first local router before the request for a translation can be routed by any one of the plurality of node computers in the first branch.

12. The method of claim 9 further comprising
configuring the first set of a plurality of client computers to communicate with the plurality of node computers in a first branch through the internet; and
configuring the second set of a plurality of client computers to communicate with the plurality of node computers in a first branch through an intranetwork.

13. The method of claim 9 wherein
the step of routing is performed by a plurality of node computers in a second branch and the plurality of node computers in a first branch.

14. The method of claim 9 further comprising
configuring the first set of a plurality of translation service providers to communicate with the plurality of node computers in a first branch through the internet; and
configuring a second set of a plurality of translation service providers to communicate with the plurality of node computers in a first branch through an intranetwork.

15. The method of claim 11 further comprising
configuring a second local router with respect to the first set of the plurality of client computers and with respect to a plurality of node computers in a second branch so that the request for a translation from any one of the first set of the plurality of client computers must go through the second local router before the request for a translation can be routed by any one of the plurality of node computers in the second branch.

16. The method of claim 9 further comprising
configuring a view/file server array so that it hosts one view file for each language translated, so that a plurality of view files are hosted by the view/file server array for a corresponding plurality of languages translated;
wherein the plurality of a view files includes a first view file displaying words in a first language and a second view file displaying words in a second language;
and further comprising sending the first view file to a plurality of the first set of a plurality of client computers; and
sending the second view file to a plurality of the first set of a plurality of client computers.

17. The method of claim 16 wherein
the plurality of the first set of a plurality of client computers that receives the first view file, does not receive the second view file.
